(19) United States
(12) Patent Application Publication
(10) Pub. No.: US 2013/0033516 A1
(43) Pub. Date: Feb. 7, 2013

(54) METHOD OF GENERATING A FINAL COLOUR VERSION OF A SOURCE IMAGE FROM A FIRST SET OF DIFFERENT INTERMEDIATE COLOUR VERSIONS

(71) Applicants: Jürgen Stauder, Montreuil / Ille (FR); Hassane Guermoud, Cesson-Sevigne (FR); Laurent Blondé, (US)

(72) Inventors: Jürgen Stauder, Montreuil / Ille (FR); Hassane Guermoud, Cesson-Sevigne (FR); Laurent Blondé, (US)

(21) Appl. No.: 13/558,310

(22) Filed: Jul. 25, 2012

(30) Foreign Application Priority Data
Aug. 2, 2011 (EP) 11306007.3

(51) Int. Cl. G09G 5/02

(52) U.S. Cl. 345/589

(57) ABSTRACT

This method comprises the following steps:
displaying the different intermediate colour versions,
from a visual comparison between displayed versions, selecting a second set,
determining an intermediate colour transform able to transform an original version of said source image into each of said selected intermediate colour versions by a comparison between the original version of said source image with the selected intermediate colour version,
building a final colour transform by combining each of the determined intermediate colour transforms,
generating the final colour version by applying the built final colour transform to the original version of said source image.

### TECHNICAL FIELD

The invention relates to the sharing and the mixing of different colours versions of a same source image.

### BACKGROUND ART

In consumer as well as in professional applications, there are various color transform tools for changing colors, also called color correction, color grading or color manipulation. This invention addresses the problem of communication of color changes that result from such operations. For example, several color editing persons dispose of an identical original version of a given source image. Each of those colour editing persons change colors in the original version of their source image resulting to an intermediate colour version of the same source image per person. The problem is: how can these color editing persons share their color changes with another, specific person and how can this specific person make use of the different color changes to define by himself a final color change resulting in a final colour version of this source image ? The document EP1206124 disclosed a method of generating a final colour version of a source image from a first set of different intermediate colour versions of said source image that are each generated using a known intermediate colour transform applied to an original version of the source image with at least one colour processing parameter for said generation, comprising the steps of:

rendering the different intermediate colour versions of said source image,

from a visual comparison between displayed versions, selecting a second set of a plurality of intermediate colour versions within said first set,

assigning a weight to each of said selected intermediate colour versions (see paragraph 23),

building a final colour transform by combining each of the intermediate colour transforms corresponding to the selected intermediate colour versions of this second set with a weight equal to the weight assigned to the selected intermediate colour version corresponding to this intermediate colour transform,

generating said final colour version by applying to the original version of the source image a final colour transform.

The problem of sharing and mixing colour changes is more difficult when the colour transform tool and associated parameters that have been used by the different editing persons are not available. For example, the final colour editing persons use different tool than the other editing persons. Then, colour transforms and parameters cannot be exchanged. Often, such tools allow outputting changed image content but does not allow to output metadata information about the nature of the color changes. If tools output such metadata, it may not be readable by another tool.

### SUMMARY OF INVENTION

An object of the invention is to solve the aforementioned problem by proposing to add a step to the above mentioned method, wherein each colour transform corresponding to a selected intermediate colour version is derived from a comparison between this selected intermediate colour version with the original version of the source image.

The subject of the invention is then a method of generating a final colour version of a source image from a first set of different intermediate colour versions of said source image, comprising the steps of:

displaying the different intermediate colour versions of said first set,

from a visual comparison between displayed versions, selecting a second set of these intermediate colour versions within said first set,

determining an intermediate colour transform able to transform an original version of said source image into each of said selected intermediate colour versions by a comparison between the original version of said source image with the selected intermediate colour version,

building a final colour transform by combining each of the determined intermediate colour transforms,

generating the final colour version by applying the built final colour transform to the original version of said source image.

Preferably, this method comprises also the following steps:

assigning a weight to each of said selected intermediate colour versions of second set,

combining each of the determined intermediate colour transforms with a weight equal to the weight assigned to the selected intermediate colour version corresponding to said determined intermediate colour transform.

The intermediate images derives from the same source image through different colour processing. For instance, different users receive the same source image and decide to use their own colour processing tools to transform according to their own settings the same source image into different intermediate images. After such a colour processing, all intermediate images may have only in common the same geometrical features.

According to a first variant, said final color transform is built from a linear combination of the determined intermediate colour transforms.

According to a second variant, said final color transform Tr_F′ is built from a non-linear combination of the determined intermediate colour transforms based on dominating color aspects.

Preferably, the method comprises the step of generating said different intermediate colour versions at different locations by using different colour processing tools.

Preferably, in this method, said final colour transform determination comprises the step of dividing the color gamut of the source image into original tetrahedrons and the step of assigning a modified tetrahedron to each original tetrahedron, and said application of said built final colour transform to the original version of said source image to generate said final version is performed according to the following steps:
a) For each pixel of the original version of the source image having a given pixel color, identify an original tetrahedron that contains this pixel color and determine the color coordinates of the vertices of this original tetrahedron XYZ₀, XYZ₁, XYZ₂, XYZ₃;
b) Identify the corresponding modified tetrahedron by the color coordinates of its vertices RGB₀, RGB₁, RGB₂, RGB₃;
c) Calculate a determinant “det” for the original tetrahedron according to:

$$det = \vert \begin{matrix}{a}_{XYZ} & {b}_{XYZ} & {c}_{XYZ} \\ {a}_{XYZ}^{′} & {b}_{XYZ}^{′} & {c}_{XYZ}^{′} \\ {a}_{XYZ}^{″} & {b}_{XYZ}^{″} & {c}_{XYZ}^{″}\end{matrix} \vert$$

$$with$$

$$\begin{matrix}{a}_{XYZ} = {X}_{1} - {X}_{0} , & {a}_{XYZ}^{′} = {Y}_{1} - {Y}_{0} , & {a}_{XYZ}^{″} = {Z}_{1} - {Z}_{0} \\ {b}_{XYZ} = {X}_{2} - {X}_{0} , & {b}_{XYZ}^{′} = {Y}_{2} - {Y}_{0} , & {b}_{XYZ}^{″} = {Z}_{2} - {Z}_{0} \\ {c}_{XYZ} = {X}_{3} - {X}_{0} , & {c}_{XYZ}^{′} = {Y}_{3} - {Y}_{0} , & {c}_{XYZ}^{″} = {Z}_{3} - {Z}_{0}\end{matrix}$$

d) Then, calculate three coefficients according to:

$${u}_{s} = \frac{\vert \begin{matrix}{d}_{XYZ} & {b}_{XYZ} & {c}_{XYZ} \\ {d}_{XYZ}^{′} & {b}_{XYZ}^{′} & {c}_{XYZ}^{′} \\ {d}_{XYZ}^{″} & {b}_{XYZ}^{″} & {c}_{XYZ}^{″}\end{matrix} \vert}{det} , \\ {v}_{s} = \frac{\vert \begin{matrix}{a}_{XYZ} & {d}_{XYZ} & {c}_{XYZ} \\ {a}_{XYZ}^{′} & {d}_{XYZ}^{′} & {c}_{XYZ}^{′} \\ {a}_{XYZ}^{″} & {d}_{XYZ}^{″} & {c}_{XYZ}^{″}\end{matrix} \vert}{det} , \\ {w}_{s} = \frac{\vert \begin{matrix}{a}_{XYZ} & {b}_{XYZ} & {d}_{XYZ} \\ {a}_{XYZ}^{′} & {b}_{XYZ}^{′} & {d}_{XYZ}^{′} \\ {a}_{XYZ}^{″} & {b}_{XYZ}^{″} & {d}_{XYZ}^{″}\end{matrix} \vert}{det} , \\ with {d}_{XYZ} = {X}_{s} - {X}_{0} , {d}_{XYZ}^{′} = {Y}_{s} - {Y}_{0} , {d}_{XYZ}^{″} = {Z}_{s} - {Z}_{0}$$

e) Calculate the modified pixel color RGB_{S} of the final version according to:

Rₛ=a_{RGB}uₛ+b_{RGB}vₛ+c_{RGB}wₛ+R₀

Gₛ=a_{RGB}′uₛ+b_{RGB}′vₛ+c_{RGB}′wₛ+G₀Bₛ=a_{RGB}″uₛ+b_{RGB}″vₛ+c_{RGB}″wₛ+B₀

with:

a_{RGB}−R₁−R₀, a_{RGB}′=G₁−G₀, a_{RGB}″=B₁−B₀

b_{RGB}=R₂−R₀, b_{RGB}′=G₂−G₀, b_{RGB}″=B₂−B₀

c_{RGB}=R₃−R₀, c_{RGB}′=G₃−G₀, c_{RGB}″=B₃−B₀

The subject of the invention is also a method of generating a final colour version of a source video content comprising a succession of images, comprising the steps of selecting an image in an original version of said source video content considered as an original version of a source image, generating a first set of different intermediate colour versions of said selected source image, generating a final colour version of said source image from said first set of different intermediate colour versions of said source image according to the method above, and generating said final colour version of said source video content by applying said built final colour transform to all successive images of said source video content.

### BRIEF DESCRIPTION OF THE DRAWING

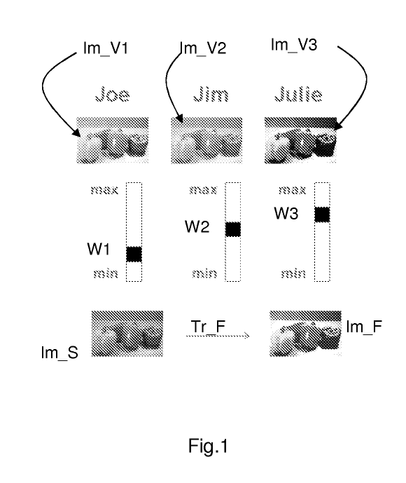

The invention will be more clearly understood on reading the description which follows, given by way of non-limiting example and with reference to the appended figures in which FIG. 1 illustrates an example of a preferred embodiment of the method according to the invention.

### DESCRIPTION OF EMBODIMENTS

The functions of the various elements shown in this FIGURE may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

The following example illustrates a preferred embodiment of a method according to the invention in reference to FIG. 1.

In this example, the method according to the invention is implemented for personal users of internet. Three friends, named Joe, Jim and Julie, use a web-based application for sharing color changes. Each friend is watching the same original version of a color source video content VC_S chosen, for instance, from a Video on Demand catalogue. One friend selects an image in this source video content VC_S and share this image with his friends by Internet, this image being considered an original version of a source image. Preferably, this image is selected in a manner known per se as representative of the source video content VC_S. This selected image can also correspond the first frame of the source video content VC_S. Each friend then applies a color change according to his personal taste to the shared original version of this selected source image Im_S and then generates his own intermediate colour version Im_V1, Im_V2, Im_V3 of the same source image Im_S. A first set of different intermediate colour versions Im_V1, Im_V2, Im_V3 of a same source image is then generated. Each friend shares though the Internet the three intermediate colour versions Im_V1, Im_V2, Im_V3 of this first set with the other friends. Any other means of generation of this first set of different intermediate colour versions of a same source image can be considered without departing from the invention.

These different intermediate colour versions can notably be generated at the same location, notably when the friends belong to the same family and are located in the same house. To get the different intermediate colour versions, the application of a color change to the original source image can be performed using different or identical color processing tools.

Then, on his own colour display device, each friend displays the original version of the source image Im_S with the three different intermediate colour versions Im_V1, Im_V2, Im_V3 of the same source image.

From a visual comparison between the different versions displayed on his own colour display device, each friend selects two or three of the three intermediate colour versions Im_V1, Im_V2, Im_V3, and using scroll bars as illustrated on FIG. 1, chooses a weight W1, W2, W3 for each of the selected intermediate colour versions. Here, all intermediate colour versions are selected, but only a portion but a plurality of these intermediate colour versions can be selected without departing from the invention. As described above, an intermediate colour transform Tr_V1, Tr_V2, Tr_V3 corresponding to each of the selected intermediate colour versions Im_V1, Im_V2, Im_V3 is determined from a comparison between this selected intermediate colour version with the original version of the source image Im_S. Using the assigned weights W1, W2, W3, a related, interpolated, weighted final color transform Tr_F is calculated and applied to the original version of the source image Im_S to get the final colour version Im_F. Then, the final color transform Tr_F is applied to the entire video content to get a final version of this video content.

The determination of an intermediate colour transform from an original version of a source image Im_S and an intermediate colour version Im_Vx is done for example by the following steps:
a) Building pairs of corresponding colors from the original version of the source image Im_S and from the intermediate colour version Im_Vx, each pair consisting of an original color XYZₛ and a modified color RGBₛ;
b) Building an original tetrahedralization of the original colors of the source image in color space and a corresponding modified tetrahedralization of the modified colors of the intermediate colour version Im_Vx.

Each intermediate colour transform Tr_V1, Tr_V2, Tr_V3 corresponding to a selected intermediate colour version is then determined by such a comparison between this selected intermediate colour version Im_V1, Im_V2, Im_V3 with the original version of the same source image Im_S, this comparison being done by the building of pairs of corresponding colors as mentioned above.

At the end of the process, the generation of the final version Im_F by the application of the final color transform to the original version of the source image Im_S is done for example by the following steps:
a) For each pixel of the original version of the source image Im_S having a given pixel color, identify the original tetrahedron that contains this pixel color, the color coordinates of the vertices of the original tetrahedron being XYZ₀, XYZ₁, XYZ₂, XYZ₃;
b) Identify the corresponding modified tetrahedron by the color coordinates of its vertices RGB₀, RGB₁, RGB₂, RGB₃;
c) Calculate a determinant “det” for the original tetrahedron according to:

$$det = \vert \begin{matrix}{a}_{XYZ} & {b}_{XYZ} & {c}_{XYZ} \\ {a}_{XYZ}^{′} & {b}_{XYZ}^{′} & {c}_{XYZ}^{′} \\ {a}_{XYZ}^{″} & {b}_{XYZ}^{″} & {c}_{XYZ}^{″}\end{matrix} \vert$$

$$with$$

$$\begin{matrix}{a}_{XYZ} = {X}_{1} - {X}_{0} , & {a}_{XYZ}^{′} = {Y}_{1} - {Y}_{0} , & {a}_{XYZ}^{″} = {Z}_{1} - {Z}_{0} \\ {b}_{XYZ} = {X}_{2} - {X}_{0} , & {b}_{XYZ}^{′} = {Y}_{2} - {Y}_{0} , & {b}_{XYZ}^{″} = {Z}_{2} - {Z}_{0} \\ {c}_{XYZ} = {X}_{3} - {X}_{0} , & {c}_{XYZ}^{′} = {Y}_{3} - {Y}_{0} , & {c}_{XYZ}^{″} = {Z}_{3} - {Z}_{0}\end{matrix}$$

d) Then, calculate three coefficients according to:

$${u}_{s} = \frac{\vert \begin{matrix}{d}_{XYZ} & {b}_{XYZ} & {c}_{XYZ} \\ {d}_{XYZ}^{′} & {b}_{XYZ}^{′} & {c}_{XYZ}^{′} \\ {d}_{XYZ}^{″} & {b}_{XYZ}^{″} & {c}_{XYZ}^{″}\end{matrix} \vert}{det} , \\ {v}_{s} = \frac{\vert \begin{matrix}{a}_{XYZ} & {d}_{XYZ} & {c}_{XYZ} \\ {a}_{XYZ}^{′} & {d}_{XYZ}^{′} & {c}_{XYZ}^{′} \\ {a}_{XYZ}^{″} & {d}_{XYZ}^{″} & {c}_{XYZ}^{″}\end{matrix} \vert}{det} , \\ {w}_{s} = \frac{\vert \begin{matrix}{a}_{XYZ} & {b}_{XYZ} & {d}_{XYZ} \\ {a}_{XYZ}^{′} & {b}_{XYZ}^{′} & {d}_{XYZ}^{′} \\ {a}_{XYZ}^{″} & {b}_{XYZ}^{″} & {d}_{XYZ}^{″}\end{matrix} \vert}{det} , \\ with {d}_{XYZ} = {X}_{s} - {X}_{0} , {d}_{XYZ}^{′} = {Y}_{s} - {Y}_{0} , {d}_{XYZ}^{″} = {Z}_{s} - {Z}_{0}$$

e) Calculate the modified pixel color RGB_{S} of the final version Im_F according to:

Rₛ=a_{RGB}uₛ+b_{RGB}vₛ+c_{RGB}wₛ+R₀

Gₛ=a_{RGB}′uₛ+b_{RGB}′vₛ+c_{RGB}′wₛ+G₀Bₛ=a_{RGB}″uₛ+b_{RGB}″vₛ+c_{RGB}″wₛ+B₀

with:

a_{RGB}−R₁−R₀, a_{RGB}′=G₁−G₀, a_{RGB}″=B₁−B₀

b_{RGB}=R₂−R₀, b_{RGB}′=G₂−G₀, b_{RGB}″=B₂−B₀

c_{RGB}=R₃−R₀, c_{RGB}′=G₃−G₀, c_{RGB}″=B₃−B₀

A simple interpolation rule may not be satisfying for the proposed interactive application as described above between different friends. See for instance the problem that may rise between these friends if the building of the final colour transform is simply a linear combination of the intermediate color transforms:
Joe proposes an intermediate colour version Im_V1 showing a strongly desaturated and slightly bluish version.
Jim proposes an intermediate colour version Im_V2 showing a strong yellow cast and slight saturation changes.

When the user now chooses between Joe's and Jim's proposal using a weighting slider, he probably wants:
When choosing Joe's version, the user want to select desaturation
When choosing Jim's version, the user wants to choose the yellow cast.

The user probably does not want:
To mix bluish and yellow cast (becoming violet)
To mix desaturation and saturation (resulting in no significant change)

According to an advantageous variation of the invention which is intended to solve this problem, the final color transform Tr_F′ is now built from dominating color aspects and not, in a linear manner as above, from all color coordinates.

### EXAMPLE

In Joe's proposal, the desaturation is the strongest aspect of color change. When the user uses Joe's proposal for calculating the color change, the color change will include a change of saturation.
In Jim's proposal, the yellow cast is the strongest aspect of color change. When the user uses Jim's proposal for calculating the color change, the color change will include a change of hue.

Although the illustrative embodiments have been described herein with reference to a given example with a variant, it is to be understood that the invention is not limited to this precise example and variant, and that various changes and modifications may be effected therein by one of ordinary skill in the pertinent art without departing from the invention. All such changes and modifications are intended to be included within the scope of the appended claims.

1. Method of generating a final colour version of a source image from a first set of different intermediate colour versions of said source image, comprising the steps of:
displaying the different intermediate colour versions of said first set,
from a visual comparison between displayed versions, selecting a second set of these intermediate colour versions within said first set,
an intermediate colour transform able to transform an original version of said source image into each of said selected intermediate colour versions being determined, building a final colour transform by combining linearly each of the determined intermediate colour transforms,
generating said final colour version by applying said built final colour transform to the original version of said source image,
wherein each intermediate colour transform corresponding to a selected intermediate colour version is determined by a comparison between said selected intermediate colour version with the original version of said source image.

2. Method according to claim 1 comprising also the steps of assigning a weight to each of said selected intermediate colour versions, wherein the weight of each of the determined intermediate colour transforms in said linear combination corresponds to said assigned weight of said selected intermediate colour version.

3. Method according to claim 1 comprising the step of generating said different intermediate colour versions at different locations by using different colour processing tools.

4. Method according to claim 1 wherein said final colour transform determination comprises the step of dividing the color gamut of the source image into original tetrahedrons and the step of assigning a modified tetrahedron to each original tetrahedron, and wherein said application of said built final colour transform to the original version of said source image to generate said final version is performed according to the following steps:
a) For each pixel of the original version of the source image having a given pixel color, identify an original tetrahedron that contains this pixel color and determine the color coordinates of the vertices of this original tetrahedron XYZ₀, XYZ₁, XYZ₂, XYZ₃;
b) Identify the corresponding modified tetrahedron by the color coordinates of its vertices RGB₀, RGB₁, RGB₂, RGB₃;
c) Calculate a determinant “det” for the original tetrahedron according to:
$$det = \vert \begin{matrix}{a}_{XYZ} & {b}_{XYZ} & {c}_{XYZ} \\ {a}_{XYZ}^{′} & {b}_{XYZ}^{′} & {c}_{XYZ}^{′} \\ {a}_{XYZ}^{″} & {b}_{XYZ}^{″} & {c}_{XYZ}^{″}\end{matrix} \vert$$
$$with$$
$$\begin{matrix}{a}_{XYZ} = {X}_{1} - {X}_{0} , & {a}_{XYZ}^{′} = {Y}_{1} - {Y}_{0} , & {a}_{XYZ}^{″} = {Z}_{1} - {Z}_{0} \\ {b}_{XYZ} = {X}_{2} - {X}_{0} , & {b}_{XYZ}^{′} = {Y}_{2} - {Y}_{0} , & {b}_{XYZ}^{″} = {Z}_{2} - {Z}_{0} \\ {c}_{XYZ} = {X}_{3} - {X}_{0} , & {c}_{XYZ}^{′} = {Y}_{3} - {Y}_{0} , & {c}_{XYZ}^{″} = {Z}_{3} - {Z}_{0}\end{matrix}$$
d) Then, calculate three coefficients according to:
$${u}_{s} = \frac{\vert \begin{matrix}{d}_{XYZ} & {b}_{XYZ} & {c}_{XYZ} \\ {d}_{XYZ}^{′} & {b}_{XYZ}^{′} & {c}_{XYZ}^{′} \\ {d}_{XYZ}^{″} & {b}_{XYZ}^{″} & {c}_{XYZ}^{″}\end{matrix} \vert}{det} , \\ {v}_{s} = \frac{\vert \begin{matrix}{a}_{XYZ} & {d}_{XYZ} & {c}_{XYZ} \\ {a}_{XYZ}^{′} & {d}_{XYZ}^{′} & {c}_{XYZ}^{′} \\ {a}_{XYZ}^{″} & {d}_{XYZ}^{″} & {c}_{XYZ}^{″}\end{matrix} \vert}{det} , \\ {w}_{s} = \frac{\vert \begin{matrix}{a}_{XYZ} & {b}_{XYZ} & {d}_{XYZ} \\ {a}_{XYZ}^{′} & {b}_{XYZ}^{′} & {d}_{XYZ}^{′} \\ {a}_{XYZ}^{″} & {b}_{XYZ}^{″} & {d}_{XYZ}^{″}\end{matrix} \vert}{det} , \\ with {d}_{XYZ} = {X}_{s} - {X}_{0} , {d}_{XYZ}^{′} = {Y}_{s} - {Y}_{0} , {d}_{XYZ}^{″} = {Z}_{s} - {Z}_{0}$$
e) Calculate the modified pixel color RGB_{S} of the final version according to:
Rₛ=a_{RGB}uₛ+b_{RGB}vₛ+c_{RGB}wₛ+R₀
Gₛ=a_{RGB}′uₛ+b_{RGB}′vₛ+c_{RGB}′wₛ+G₀Bₛ=a_{RGB}″uₛ+b_{RGB}″vₛ+c_{RGB}″wₛ+B₀
with:
a_{RGB}−R₁−R₀, a_{RGB}′=G₁−G₀, a_{RGB}″=B₁−B₀
b_{RGB}=R₂−R₀, b_{RGB}′=G₂−G₀, b_{RGB}″=B₂−B₀
c_{RGB}=R₃−R₀, c_{RGB}′=G₃−G₀, c_{RGB}″=B₃−B₀

5. Method of generating a final colour version of a source video content comprising a succession of images, comprising the steps of selecting an image in an original version of said source video content considered as an original version of a source image, generating a first set of different intermediate colour versions of said selected source image, generating a final colour version of said source image from said first set of different intermediate colour versions of said source image according to the method of claim 1, and generating said final colour version of said source video content by applying said built final colour transform to all successive images of said source video content.
